(19) United States
(12) Patent Application Publication
(10) Pub. No.: US 2009/0218945 A1
(43) Pub. Date: Sep. 3, 2009

(54) Member for Plasma Display and Method for Producing the Same

(76) Inventors: Minori Kamada, Shiga (JP); Yoshiyuki Tsuji, Hokkaido (JP); Atsushi Kondo, Shiga (JP)

Correspondence Address: KUBOVCIK & KUBOVCIK, SUITE 1105, 1215 SOUTH CLARK STREET, ARLINGTON, VA, 22202, US

(21) Appl. No.: 12/224,503

(22) PCT Filed: Feb. 19, 2007
(86) PCT No.: PCT/JP2007/052914

§ 371 Date: Feb. 2, 2009

(30) Foreign Application Priority Data
Feb. 28, 2006 (JP) 2006-052453

(51) Int. Cl. H01J 17/49; H01J 9/00

(52) U.S. Cl. 313/582; 445/24

(57) ABSTRACT

[PROBLEMS] To provide a member for plasma display having a lattice-like partition consisting of at least a main partition and an auxiliary partition formed on a substrate in which the height at the partition of the main partition is prevented from becoming smaller than the height at an intersection even when a high precision lattice-like partition where the width at the top of the main partition becomes 40 μm or less is provided, and the problem of erroneous emission of light from a cell is eliminated.

[MEANS FOR SOLVING PROBLEMS] In a structure where the width at the top of the main partition is 40 μm or less and the main and auxiliary partitions are arranged in lattice, the height at the intersection of the main and auxiliary partitions is set to be 0-2μ smaller than the height at the main partition by setting the relation between the width (Wa) at the top of the main partition and the width (Wb) at the top of the auxiliary partition to satisfy 1.2≦(Wa/Wb).

### TECHNICAL FIELD

The present invention relates to a member for plasma display and a method for producing the same.

### BACKGROUND ARTS

A plasma display panel (hereafter, referred to as PDP) has attracted attention in a display capable of using for flat and large screen TV. For example of PDP construction, at glass substrate of front panel side that is the display surface, plural coupled sustain electrodes are formed with a material such as silver, chrome, aluminum or nickel. Furthermore, a dielectric layer, of which main component is a glass, covering the sustain electrodes is formed in a thickness of 20 to 50 μm, and an MgO layer covering the dielectric layer is formed. On the other hand, on glass substrate of rear panel side, plural address electrodes are formed in nearly stripe-like fashion, and a dielectric layer of which main component is a glass is formed covering the address electrodes. On the dielectric layer, barrier ribs are formed for partitioning discharge cells, and phosphor layers are formed in discharge spaces formed by the barrier ribs and the dielectric layer. In a PDP capable of displaying in full color, the phosphor layers consist of those that emit red (R), green (G) and blue (B), respectively.

The front panel and the rear panel are sealed and bonded in such a way that the sustain electrodes of the glass substrate of front panel side and the address electrodes of rear panel side would cross at right angle, and a PDP is formed by filling a noble gas consisting such as of helium, neon or xenon in the gap between those substrates. Pixel cells are formed at intersections of scan electrodes and the address electrodes as their centers, and accordingly, the PDP has plural pixel cells to enable to display an image.

At displaying an image by a PDP, in a selected pixel cell, when a sparkover voltage or more is applied between the sustain electrodes and the address electrodes in a state in which no light is emitted, cations or electrons generated by an ionization move to electrodes of opposite polarity in the discharge space since the pixel cell is a capacitive load and charge inner wall of the MgO layer, and the charge of the inner wall remains without attenuation due to a high resistivity of the MgO layer.

Next, a discharge sustaining voltage is applied between the scan electrodes and the sustain electrodes. It is possible to discharge even at a voltage lower than the sparkover voltage where the wall charge is present. By the discharge, xenon gas in the discharge space is excited, and UV ray at 147 nm is generated and a light emission becomes possible by exciting the phosphor by the UV ray. In such a PDP, it becomes important to enhance brightness in case where the phosphor surface emits light. As means for enhancing the brightness, it is proposed to increase light emitting area of the phosphor surface by forming the phosphor surface on surface of auxiliary barrier ribs by providing a lattice-like barrier rib consisting of main barrier ribs and the auxiliary barrier ribs, to thereby efficiently force the UV ray to function to the phosphor surface to enhance the brightness (for example, refer to Patent reference 1).

Regarding formation of the above-mentioned lattice-like barrier rib, it is general to form a lattice-like barrier rib pattern by a method such as coating a glass paste containing a low melting point glass powder and an organic component on the substrate on which address electrodes and a dielectric layer are provided, and patterning by a sandblast or a photolithography method, or by carrying out pattern printing by a mold transfer method or a screen printing method, and then carrying out a firing and removing the organic component to form a lattice-like barrier rib of which main component is the low melting point glass.

On the other hand, in order to prepare for a full spec High-Vision display, making the display into a high definition is demanded. Concretely, in the above-mentioned lattice-like barrier rib, it becomes necessary to make width of the main barrier rib at least 40 μm or less.

However, when such a high definition lattice-like barrier. rib of which width of the main barrier rib is 40 μm or less is tried to be made by a method using the above-mentioned glass paste, since it shrinks at firing due to the removal of the organic component, there was a problem that the intersections of the main barrier ribs and the auxiliary barrier ribs are high, and the height of the main barrier rib between an intersection and an intersection, i.e., of the portion partitioning discharge spaces of neighboring display cells (hereafter, referred to as partitioning portion) becomes low. As mentioned here, when the height of the main barrier rib at intersection with the auxiliary barrier rib is high and it is low at the partitioning portion, since not only it causes a color mixing at forming phosphor layers, but also the function of the main barrier rib to partition the discharge spaces cannot be sufficiently attained, it cause a significant deterioration of display characteristics as a PDP panel.
[Patent Document 1] JP10321148A

### DISCLOSURE OF THE INVENTION

### Problems to be Solved by the Invention

The purpose of the present invention is, in a member for plasma display in which a lattice-like barrier rib consisting of at least main barrier ribs and auxiliary barrier ribs is formed on a substrate, even in case where a high definition lattice-like barrier rib of which width of the top of main barrier rib is 40 μm or less is provided, the height of the main barrier rib at partitioning portion is prevented to be lower than the height at intersection to provide a member for plasma display in which a problem of erroneous light emission of a cell is solved.

### Means for Solving the Problem

That is, the present invention relates to a member for display having, on a substrate, nearly stripe-like address electrodes, a dielectric layer covering the address electrodes, and a lattice-like barrier rib, present on the dielectric layer, consisting of main barrier ribs which are parallel to said address electrodes and auxiliary barrier ribs which intersect with the main barrier ribs, and the member for display is characterized in that a width at the top of said main barrier rib, Wa (μm), and a width at the top of said auxiliary barrier rib, Wb (μm), satisfy the following equations (1) and (2).

Wa≦40 (1)

Wb/Wa≧1.2 (2)

In addition, the present invention relates to a production method for a member for display in which a lattice-like barrier rib consisting of main barrier ribs which are parallel to said address electrode and auxiliary barrier ribs which intersect with the main barrier ribs is formed, in which nearly stripe-like address electrodes and a dielectric layer covering the address electrodes are provided on a substrate, a glass paste containing a low melting point glass powder and an organic component is coated on the dielectric layer to form a lattice-like barrier rib pattern consisting of the glass paste coating film, and then fired, wherein said method for producing a member for display is characterized in that a width of the top of said main barrier rib, Wa (μm), and a width of the top of said auxiliary barrier rib, Wb (μm), are patterned in such a way that the following equations (1) and (2) are satisfied.

Wa≦40 (1)

Wb/Wa≧1.2 (2)

### EFFECT OF THE INVENTION

According to the present invention, in a member for plasma display in which a lattice-like barrier rib consisting at least of main barrier ribs and auxiliary barrier ribs on a substrate, even in case where a high definition lattice-like barrier rib of which width of the top of main barrier rib is 40 μm or less is provided, it is possible to prevent a height of the main barrier rib at partitioning portion to be lower than a height at intersection to provide a member for plasma display in which a problem of erroneous emission of a cell is solved.

### BRIEF EXPLANATION OF THE DRAWINGS

FIG. 1 is a schematic perspective view showing an example of a member for plasma display of the present invention.

FIG. 2 is a schematic plan view of an example of a member for plasma display of the present invention.

FIG. 3 is an A-A cross-sectional view of the member for plasma display of FIG. 2.

### EXPLANATION OF CODES

1 substrate
2 address electrode
3 dielectric layer
4 main barrier rib
5 auxiliary barrier rib
6 measuring position of height of main barrier rib at intersection (Ha₁)
7 measuring position of height of main barrier rib at partitioning portion (Ha₂)
Wa width of top of main barrier rib
Wb width of top of auxiliary barrier rib
Ha₁ height of main barrier rib at intersection
Ha₂ height of main barrier rib at partitioning portion
Hb height of auxiliary barrier rib

### THE BEST MODE FOR CARRYING OUT THE INVENTION

Hereafter, the present invention is explained in detail with reference to the drawings.

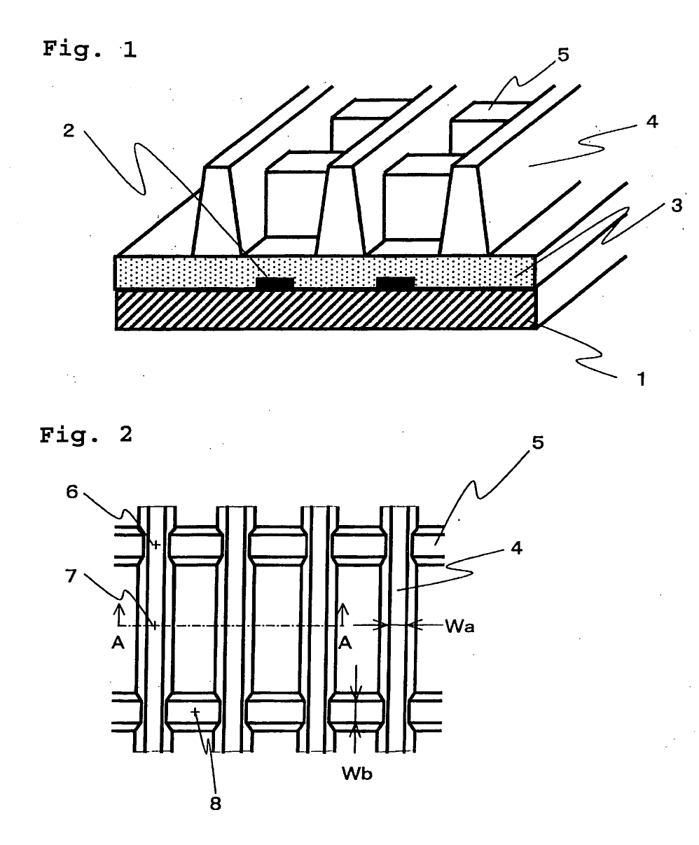

FIG. 1 shows an embodiment of a member for plasma display for carrying out the present invention.

As the substrate 1 of the present invention used for rear panel as a member for PDP, a soda glass, a heat-resistant glass for PDP or the like can be used, and concretely, PD200 produced by Asahi Glass Co., Ltd., PP8 produced by Nippon Electric Glass Co., Ltd. or the like are mentioned.

In the present invention, the nearly stripe-like address electrodes 2 are formed on the substrate 1 with a metal such as silver, aluminum, chrome, nickel or the like. As methods of the formation, a method of pattern printing a metal paste of which main components are metal powder of those metals and an organic binder, or a photosensitive paste method in which a metal pattern is formed by, after coating a photosensitive metal paste in which a photosensitive organic component is used as organic binder, implementing it to a pattern exposure by using a photo mask, dissolving and removing unnecessary portion by a development step, and further implementing to a heating and firing at 400 to 600° C. to form a metal pattern, can be employed. On the other hand, an etching method can be employed in which a resist is coated after sputtering a metal such as chrome, aluminum or the like on a glass substrate, and the metal in unnecessary portion is removed after the resist is implemented to a pattern exposure and development. As a thickness of the electrode, 1 to 10 μm is preferable and 1.5 to 8 μm is more preferable. When the thickness of the electrode is too thin, a defect of pattern may become likely to generate, or resistivity may become high, which may cause a difficulty of correct driving. On the other hand, if it is too thick, an excessive material becomes necessary, and it may be disadvantageous in cost. A width of the address electrode 2 is preferably 20 to 200 μm, and more preferably, 30 to 150 μm. When the width of the address electrode 2 is too narrow, defects such as a disconnection or shortage may become likely to arise and process yield decreases, or resistivity becomes high and it may cause a difficulty of a correct driving. On the other hand, if it is too wide, there may be an inclination such as reactive power increases, or a short circuit may occur since distance between neighboring electrodes decreases. Furthermore, the address electrodes 2 were formed in a pitch that depends on display cell (domain which forms emission region of pixel of each color of respective RGB). It is preferable that the electrodes are formed in a pitch of 50 to 500 μm in an ordinary PDP and in a pitch of 50 to 250 μm in a high definition PDP. Whereas, in the present invention, the “nearly stripe-like” means a pattern having a stripe-like pattern, or a stripe-like pattern electrode of which part is thickened or curved.

Next, the dielectric layer 3 is formed. The dielectric layer 3 can be formed by, after coating a glass paste for forming a dielectric layer of which main components are a glass powder and an organic binder in a form of covering the address electrodes 2, firing at 400 to 600° C. For the glass paste for forming the dielectric layer used for the dielectric layer 3, a glass powder containing at least one kind of lead oxide, bismuth oxide, zinc oxide and phosphorus oxide, and containing those 10 to 80 wt % in total, can preferably be used. By making those component 10 wt % or more, a firing at 600° C. or less becomes easy, and by making 80wt % or less, crystallization is prevented to prevent a decrease of transmission.

As the organic binder used for the glass paste for forming the above-mentioned dielectric layer, cellulose-based compounds represented by such as ethyl cellulose or methyl cellulose, or acryl-based compounds such as methyl methacrylate, ethyl methacrylate, isobutyl methacrylate, methyl acrylate, ethyl acrylate or isobutyl acrylate, can be used.

In addition, additives such as a solvent or a plasticizer may be added in the glass paste for forming the dielectric layer.

As the solvent, widely used solvents such as terpineol, butyrolactone, toluene or methyl cellosolve, can be used.

Furthermore, as the plasticizer, dibutyl phthalate, diethyl phthalate or the like can be used.

Furthermore, it is possible to obtain a PDP that has a high reflectance and a high brightness by adding a filler component other than the glass powder that does not soften at firing temperature. As the filler, titanium oxide, aluminum oxide, zirconium oxide or the like is preferable, and it is especially preferable to use a titanium oxide having a particle diameter of 0.05 to 3 μm. It is preferable that an amount of filler is, in the ratio of glass powder:filler, 1:1 to 10:1. By making the amount of the filler 1/10 or more of the glass powder, it becomes possible to achieve an effect in brightness improvement. Furthermore, by making it equal amount or less to the glass powder, it is possible to maintain an ability to be fired.

Furthermore, by adding a conductive fine particle, it is possible to make a PDP that has a high reliability at driving. As the conductive fine particle, a metal powder such as of nickel or chrome is preferable, and as its particle diameter, 1 to 10 μm is preferable. By making it 1 μm or more, a sufficient effect can be exhibited and by making it 10 μm or less, it is possible to suppress unevenness on the dielectric substance to make it easy to form a barrier rib. It is preferable that the amount contained of this conductive fine particle in the dielectric layer is 0.1to 10 wt %. By making it 0.1 wt % or more, it is possible to impart electrical conductivity, and by making it 10 wt % or less, it is possible to prevent a short circuit between neighboring address electrodes.

A thickness of the dielectric layer 3 is preferably 3 to 30 μm and more preferably 3 to 15 μm. When the thickness of the dielectric layer 3 is too thin, many pinholes apt to be generated, and when it is too thick, discharge voltage increases and power consumption may increase.

In the member for plasma display of the present invention, on the dielectric layer 3, a lattice-like barrier rib consisting of the stripe-like main barrier ribs 4 which are approximately parallel to the address electrodes 2 and the auxiliary barrier ribs 5 which intersect with the main barrier ribs for partitioning the discharge cells, is formed. By having the lattice-like barrier rib, it is possible to have a phosphor layer on the wall of auxiliary barrier ribs, to enable to increase emission area. Accordingly, since ultra-violet light efficiently works on the fluorescent surface, it is possible to enhance brightness. Furthermore, by the presence of the auxiliary barrier ribs, contact area of the barrier ribs increases as a whole, and structural strength of the member is obtained. As the result, the width of barrier rib can be made narrow to make discharged capacity in the display cell portion can be increased, and discharge efficiency can be further improved.

For fabricating the above-mentioned lattice-like barrier rib, it is general that a lattice-like barrier rib pattern is formed by patterning by a sandblast method or a photolithography method which includes a coating step that a glass paste containing the low melting point glass powder and the organic component is coated on the substrate on which the address electrodes and the dielectric layer are provided, or by a method such as pattern printing by a mold transfer method or a screen printing method, and then implemented to a firing to remove the organic component to form a lattice-like barrier rib of which main component is the low melting point glass. The substrate size and the number of pixels define the pitch of main barrier ribs. For example, in a Hi-Vision type (HD or XGA), the number of pixels in width direction of panel is 1024 to 1366 or, and in RGB 3 colors, 3072 to 4098 cells. Accordingly, in case where the substrate size is 42 inches, the size in width direction is approximately 900 mm, and in case of 50 inches, it is 1100 mm, and therefore, their pitches are approximately 0.3 to 0.35 mm, respectively. Furthermore, since the full spec Hi-Vision (FHD) has 1920 pixels, a pitch (P) of 10 μm≦P≦250 μm is often applied. By making it 10 μm or more, it is possible to secure a sufficient brightness by enlarging the discharge spaces, and by making it 350 μm or less, it is possible to display a clear and beautiful image with fine pixels. Furthermore, in case of a high definition, by making the pitch 250 μm or less, it is possible to display a beautiful image of HDTV (Hi-Vision TV) standardized level. In case where a barrier rib is formed in that pitch described above, it is necessary that the width of the top of main barrier rib, Wa (μm), satisfy the following equation (1).

Wa≦40 (1)

It is because since, in a barrier rib with a narrow pitch such as of the above-mentioned, when the width of the top of main barrier rib is larger than 40 μm, the discharge spaces become small to decrease the brightness.

In the member for plasma display having the lattice-like barrier rib, since the main barrier rib has the function of partitioning the discharge spaces of the neighboring display cells as the above-mentioned, it is necessary that the main barrier rib contact with the opposed front panel at the above-mentioned partitioning portions, i.e., at least between an intersection and an intersection, i.e., at the partitioning portions of the neighboring discharge spaces of display cell.

That is, it becomes necessary that the height of the main barrier rib at the intersection is same as the height of the main barrier rib of the partitioning portion, or it is lower than the height of the main barrier rib of the partitioning portion.

In general, in case where a lattice-like barrier rib is formed by firing a barrier rib pattern obtained from the above-mentioned glass paste, in case where the width of the top of main barrier rib is larger than 40 μm like that of a member for conventional plasma display, due to a shrinkage at firing, the height of the main barrier rib at intersection is apt to become lower than the height of the main barrier rib of the partitioning portion. In such a case, since the function of partitioning the discharge spaces at the partitioning portion works, it is unlikely that a problem arises that display characteristics become worse.

However, in a member for a high definition plasma display of which width of the top of main barrier rib is 40 μm or less, contrary to a case of which width of the top of main barrier rib is larger than 40 μm, due to the shrinkage at firing, the height of the main barrier rib of the partitioning portion is apt to become lower than the height of main barrier rib at the intersection. In such a case, since the function of partitioning the discharge spaces at the partitioning portion does not work, an erroneous discharge arises to deteriorate the display characteristics.

The inventors found that, in a member of plasma display having such a high definition lattice-like barrier rib, the above-mentioned problem can be solved by that the width of the top of main barrier rib, Wa (μm), and the width of the top of auxiliary barrier rib, Wb (μm), satisfy the following equation (2).

Wb/Wa≧1.2 (2)

Furthermore, it is more preferable that, when the width of the top of main barrier rib is 35 μm or less, Wb/Wa is 1.3 or more, when the width of the main barrier rib is 30 μm or less, Wb/Wa is 1.4 or more and when the width of the main barrier rib is 25 μm or less, Wb/Wa is 1.5 or more. In case where the Wb/Wa is less than 1.2, due to the shrinkage at firing, since the height at the intersection of the main barrier rib and the auxiliary barrier rib becomes higher than the height of the main barrier rib at the partitioning portion, when it is laminated with a front panel, it causes a gap with the main barrier rib to generate an erroneous discharge.

Upper limit of Wb/Wa is not especially limited, but to be 2.0 or less is preferable. In case where Wb/Wa is larger than 2.0, since the discharge space becomes small, a problem may arise that brightness decreases.

It is preferable, in view of efficiency of the gas discharge and the light emission of phosphor layer, that the position and pitch for forming the auxiliary barrier rib 5 are made at positions partitioning pixels when a plasma display is made by integrating with a front panel. Since it is not necessary that the auxiliary barrier rib absolutely partitions the discharge spaces, it is general to make the height of the auxiliary barrier rib lower than the height of the main barrier rib. However, when the height of the auxiliary barrier rib is excessively lower than the height of the main barrier rib, since an erroneous discharge may arise when distance between coupled sustain electrodes is made large, it is preferable, in the present invention, that the height of said main barrier rib at the center of neighboring said auxiliary barrier ribs (partitioning portion), Ha₂ (μm), and the height of said auxiliary barrier rib, Hb (μm), satisfy the following equation (3).

Ha₂−Hb<20 (3)

Furthermore, by satisfying all of the above-mentioned equations (1) to (3), it is possible to make the change of height of the main barrier rib at firing especially uniform between the intersection and the partitioning portion.

Furthermore, it is especially preferable that the height of said main barrier rib at the partitioning portion between neighboring said auxiliary barrier ribs, Ha₂ (μm), and the height of said auxiliary barrier rib, Hb (μm), satisfy the following equation (4).

Ha₂−Hb<10 (4)

In order to make Ha₂ (μm) and Hb (μm) in the range of the above equation (3) or (4), difference of heights of the barrier rib pattern before firing between a height of the portion corresponding to the auxiliary barrier rib and a height of the portion corresponding to the main barrier rib may be determined by considering the shrinkage at firing. At this time, the shrinkage at firing may be estimated by the volume ratio, etc. of the organic component (component to be removed by the firing) contained in the barrier rib pattern before the firing, or may be estimated by preparing a sample and determining the shrinkage by firing.

For example, in case where a photosensitive paste method (photolithography method) mentioned later is employed, it is possible to employ a method in which, on a substrate on which nearly stripe-like address electrodes or its precursor, and dielectric layer covering the address electrodes or its precursor are formed, first photosensitive glass paste for forming portions corresponding to lower portion of the main barrier ribs and corresponding to the auxiliary barrier ribs is coated, dried and after an exposure to make a stripe-like pattern corresponding to the auxiliary barrier ribs or a lattice-like pattern corresponding to the main barrier ribs and the auxiliary barrier ribs, second photosensitive glass paste for forming a portion corresponding to upper portion of the main barrier ribs is coated, dried and, after an exposure to make a stripe-like pattern corresponding to the main barrier ribs, it is developed to form a barrier rib pattern and by firing it, barrier ribs are formed. At this time, by determining the coating thickness of the second layer of the photosensitive paste by considering the shrinkage at drying and firing, difference between Ha₂ (μm) and Hb (μm) can be made in the range of the above equation (3) or (4). The production method for the member for display of the present invention relates to a production method for a member for display in which a lattice-like barrier rib consisting of main barrier ribs which are parallel to nearly stripe-like address electrodes and auxiliary barrier ribs which intersect with the main barrier ribs are formed, in which said address electrodes and a dielectric layer covering the address electrodes are provided on a substrate, a glass paste containing a low melting point glass powder and an organic component is coated on the dielectric layer to form a lattice-like barrier rib pattern consisting of the glass paste coating film, and then fired, wherein said method for producing a member for display is characterized in that a width of the top of said main barrier rib, Wa (μm), and a width of the top of said auxiliary barrier rib, Wb (μm), are patterned in such a way that the following equations (1) and (2) are satisfied.

Wa≦40 (1)

Wb/Wa≧1.2 (2)

As the above-mentioned, even in case where high definition barrier ribs such as of Wa≦40 (μm) are provided by firing after forming a lattice-like barrier rib pattern consisting of a coating film of the glass paste, by making Wb/Wa≧1.2, it is possible to prevent that the height of the main barrier rib at partitioning portion to be lower than the height at intersection, and a member for display in which an occurrence of erroneous discharge is few can be obtained. Next, a method for forming the main barrier ribs and the auxiliary barrier ribs in the present invention is explained. The lattice-like barrier rib consists of the main barrier ribs 4 and the auxiliary barrier ribs 5 can be formed, as the above-mentioned, by coating a glass paste containing the low melting point glass powder and the organic component on the substrate 1, and by forming a lattice-like barrier rib pattern consisting of said coating film of the glass paste by a known method such as screen print method, sandblast method, photosensitive paste method (photolithography method), mold transfer method or liftoff method, and then, by firing said lattice-like barrier rib pattern, but for reasons of shape control, uniformity, etc., among them, so-called photosensitive paste method (photolithography method) in which a photosensitive paste is coated on a substrate and it is dried to form a photosensitive paste film, and implemented to an exposure via a photo mask and to a development, is preferably employed in the present invention. Hereafter, the photosensitive paste method preferably employed in the present invention is explained in detail. The photosensitive paste used in the present invention is a composition of which main components are an inorganic fine particle containing a low melting point glass powder and a photosensitive organic component.

As the inorganic fine particle of the photosensitive paste, glass, ceramics (alumina, cordierite, etc.) or the like can be used. In particular, a glass or ceramic containing, as an essential component, oxides of silicon, oxides of boron, or oxides of aluminum is preferable, and at least, it is necessary to contain a low melting point glass powder.

Particle diameter of the inorganic fine particle is selected in consideration of a pattern to be prepared, but it is preferable that a volume-average particle-diameter (D50) is 1 to 10 μm; more preferably, it is 1 to 5 μm. By making D50 10 μm or less, it is possible to prevent a generation of surface unevenness. Furthermore, by making it 1 μm or more, it becomes possible to make viscosity control of the paste easy. Furthermore, it is especially preferable to use a glass fine particle having a specific surface area of 0.2 to 3 m²/g in the pattern formation.

It is preferable that the main barrier rib 4 and the auxiliary barrier rib 5 contain 60 wt % or more glass powder having a thermosoftening temperature of 350 to 600° C. in inorganic component as a low melting point glass powder since it is preferably patterned on a glass substrate. Furthermore, by adding a fine glass particle or ceramic fine particle having a thermosoftening temperature of 600° C. or more, it is possible to suppress shrinkage at firing, but it is preferable that the amount of adding is 40 wt % or less. As the fine glass particle to be used, in order not to cause a warpage of the glass substrate at firing, it is preferable to use a fine glass particle of which linear thermal expansion coefficient is 50×10⁻⁷ to 90×10⁻⁷ (/° C.), furthermore, 60×10⁻⁷ to 90×10⁻⁷ (/° C.).

As the fine glass particle, a glass containing an oxide of silicon and/or boron is preferably used.

It is preferable that the silicon oxide is contained in the range of 3 to 60 wt %. By making it 3 wt % or more, denseness, strength and stability of glass layer are improved, and furthermore, it is possible to make thermal expansion coefficient in a predetermined range to prevent a mismatch with the glass substrate. Furthermore, by making it 60 wt % or less, there is an advantage such that the thermosoftening point lowers and a firing to the glass substrate becomes possible.

It is possible to improve electrical, mechanical and thermal characteristics such as electrical insulating property, strength, thermal expansion coefficient, and denseness of the insulating layer by compounding the boron oxide in the range of 5 to 50 wt %. It is possible to maintain stability of glass by making a content 50 wt % or less.

Furthermore, it is possible to obtain a glass paste having temperature characteristics suitable for patterning on the glass substrate by containing 5 to 50 wt % in total of at least one kind of bismuth oxide, lead oxide and zinc oxide. In particular, when a fine glass particle containing bismuth oxide 5 to 50 wt % is used, an advantage such that life of the paste is long can be obtained. It is preferable to use a glass powder having the following composition as the bismuth-based fine glass particle.

bismuth oxide: 10 to 40 parts by weight

silicon oxide: 3 to 50 parts by weight

boron oxide: 10 to 40 parts by weight

barium oxide: 8 to 20 parts by weight

aluminum oxide: 10 to 30 parts by weight

Furthermore, a fine glass particle containing 3 to 20 wt % of at least one kind of lithium oxide, sodium oxide and potassium oxide may be used. It is possible to improve stability of the paste by making the amount of addition of the alkali metal oxide 20 wt % or less, preferably 15 wt % or less. Among the alkali metal oxide of the above-mentioned 3 kinds, lithium oxide is especially preferable in view of paste stability. As the lithium-based fine glass particle, for example, it is preferable to use the glass powder containing the composition shown in the followings.

Lithium oxide: 2 to 15 parts by weight

Silicon oxide: 15 to 50 parts by weight

Boron oxide: 15 to 40 parts by weight

Barium oxide: 2 to 15 parts by weight

Aluminum oxide: 6 to 25 parts by weight

Furthermore, when a fine glass particle containing both of a metal oxide such as lead oxide, bismuth oxide or zinc oxide and an alkali metal oxide such as lithium oxide, sodium oxide or potassium oxide is used, it is possible to easily control thermosoftening temperature and linear expansion coefficient in a lower content of alkali.

Furthermore, by adding such as aluminum oxide, barium oxide, calcium oxide, magnesium oxide, titanium oxide, zinc oxide or zirconium oxide, especially, aluminum oxide, barium oxide or zinc oxide in the fine glass particle, it is possible to improve processability, but in view of thermosoftening point and thermal expansion coefficient, it is preferable that the content is 40 wt % or less,. and more preferably 25 wt % or less.

It is preferable that the photosensitive organic component contains at least one kind of a photosensitive component selected from photosensitive monomers, photosensitive oligomers and photosensitive polymers, furthermore, as required, a photopolymerization initiator, a light absorbent, a sensitizer, an organic solvent, a sensitizer auxiliaries or a polymerization inhibitor is added.

The photosensitive monomer is a compound containing a carbon-carbon unsaturated bond, and as concrete examples, monofunctional and multifunctional (meth)acrylates, vinyl-based compounds, allyl-based compounds or the like can be used. These can be used singly or two kinds or more.

As the photosensitive oligomer or photosensitive polymer, an oligomer or polymer obtainable by polymerizing at least one kind of compound having a carbon-carbon double bond can be used. At the polymerization, it is possible to copolymerize with other photosensitive monomer in such a way that a content of the above monomer would be 10 wt % or more, more preferably 35 wt % or more.

It is possible to improve development ability after exposure by copolymerizing to the polymer or oligomer with an unsaturated acid such as an unsaturated carboxylic acid. As concrete examples of the unsaturated carboxylic acid, acrylic acid, methacrylic acid, itaconic acid, crotonic acid, maleic acid, fumaric acid, vinyl acetic acid or acid anhydrides thereof are mentioned. It is preferable that an acid value (AV) of the thus obtained polymer or oligomer having an acid group such as a carboxylic group in a side chain is in the range of 50 to 180, and the range of 70 to 140 is more preferable. By adding a photoreactive group in a side chain or molecular end to the polymer or oligomer mentioned above, it can be used as a photosensitive polymer or a photosensitive oligomer having a photosensitivity. A preferable photosensitive group is a group having an ethylenic unsaturated group. As the ethylenic unsaturated group, vinyl group, allyl group, acryl group, methacryl group or the like are mentioned.

As concrete examples of the photopolymerization initiator, benzophenone, o-benzoyl methyl benzoate, 4,4-bis(dimethyl amino) benzophenone, 4,4-bis(diethyl amino) benzophenone, 4,4-dichlorobenzophenone, 4-benzoyl-4-methyl phenyl ketone, dibenzyl ketone, fluorenone, 2,3-diethoxy acetophenone, 2,2-dimethoxy-2-phenyl-2-phenyl acetophenone or the like are mentioned. These can be used singly or two kinds or more. The photopolymerization initiator is added, with respect to the photosensitive component, preferably in the range of 0.05 to 10 wt %, more preferably, it is added in the range of 0.1 to 5 wt %. When the amount of the polymerization initiator is too small, photosensitivity may decrease, and when the amount of the photopolymerization initiator is too large, residual ratio of the exposed portion may excessively decrease.

It is also effective to add a light absorbent. By adding a compound having a high absorption effect for UV light or visible light, a high aspect ratio, a high definition and a high resolution can be obtained. As the light absorbent, those comprising an organic dye are preferably used, for example, azo-based dyes, aminoketone-based dyes, xanthene-based dyes, quinoline-based dyes, anthraquinone-based dyes, benzophenone-based dyes, diphenyl cyanoacrylate-based dyes, triazine-based dyes, p-aminobenzoic acid-based dyes or the like can be used. An organic dye is preferable since it does not remain in an insulating film after firing, therefore it can suppress deterioration of insulation characteristics by the light absorbent. Among them, azo-based and benzophenone-based dyes are preferable. It is preferable that the additive amount of organic dye is 0.05 to 5 wt %; more preferably, it is 0.05 to 1 wt %. If the amount is too small, the effect of addition the light absorbent may decrease, and if it is too excessive, insulation characteristics after firing may be impaired.

The sensitizer is added to improve sensitivity. As concrete examples of the sensitizer, 2,4-diethyl thioxanthone, isopropyl thioxanthone, 2,3-bis(4-diethyl aminobenzal) cyclopentanone, 2,6-bis(4-dimethyl aminobenzal) cyclohexanone or the like are mentioned. These can be used singly or two kinds or more. In case where the sensitizer is added to the photosensitive paste, the amount of addition is generally, with respect to the photosensitive component, 0.05 to 10 wt %, more preferably, it is 0.1 to 10 wt %. If the amount of the sensitizer is too small, the effect of photosensitivity improvement may not be exhibited, and if the amount of the sensitizer is too large, residual ratio of the exposed portion may decrease.

As the organic solvent, for example, methyl cellosolve, ethyl cellosolve, butyl cellosolve, propylene glycol monomethyl ether acetate, methyl ethyl ketone, dioxane, acetone, cyclohexanone, cyclopentanone, isobutyl alcohol, isopropyl alcohol, tetrahydrofuran, dimethyl sulfoxide, γ-butyl lactone, N-methyl pyrrolidone, N,N-dimethyl formamide, N,N-dimethyl acetamide, bromobenzene, chlorobenzene, dibromobenzene, dichlorobenzene, bromobenzoic acid, chlorobenzoic acid or the like, or an organic solvent mixture containing one kind or more of them, are used. The photosensitive paste is prepared, generally, after compounding the above-mentioned inorganic fine particle or organic component into a predetermined composition, by uniformly mixing and dispersing by a three-roll or a kneader. Successively, coating, drying, exposure, development, etc. of the photosensitive paste are carried out.

In the series of these fabricating steps, as the method of coating photosensitive paste, a screen print method, a bar coater, a roll coater, a die coater, a blade coater or the like can be used. Selecting the number of coatings, screen mesh, and viscosity, discharge pressure and coating speed can control the coating thickness of the paste.

Furthermore, for the drying after coating, a circulation drier, a hot plate, an infrared (IR) furnace, etc., can be used. As an active light source used in the exposure, for example, visual light, near-UV light, UV light, electron beam, X-ray, laser. or the like are mentioned. Among them, UV light is most preferable and as the light source, for example, a low-pressure mercury lamp, a high-pressure mercury lamp, an ultrahigh-pressure mercury lamp, a halogen lamp, a germicidal lamp, etc. can be used. Among them, an ultra-high pressure mercury lamp is preferable. Regarding the exposure condition, although it depends on the coating thickness, it is carried out by using an ultrahigh-pressure mercury lamp of 1 to 100 mW/cm² output for 0.1 to 10 minutes.

At this time, it is preferable to control the distance between the photomask and the surface of coating film of the photosensitive paste, i.e., the gap size, to 50 to 500 μm, furthermore, to 70 to 400 μm. By making the gap size to 50 μm or more, furthermore, to 70 μm or more, it is possible to prevent a contact of the coating film of the photosensitive paste with the photomask, and it is possible to prevent a breakage or a contamination of both of them. And, by making it 500 μm or less, furthermore 400 μm or less, a moderately sharp pattering becomes possible.

Regarding the development, taking advantage of a difference of solubility to a developer of the exposed portion and the unexposed portion carries it out. The development can be carried out by an immersion method, a spray method, a brush method, etc.

For the developer, a solution capable of solving the organic component to be dissolved in the photosensitive paste is used. In case where a compound has an acidic group such as carboxylic group in the photosensitive paste, it is possible to develop by an aqueous alkaline solution. As the aqueous alkaline solution, sodium hydroxide or sodium carbonate, aqueous solution of sodium carbonate, aqueous solution of calcium hydroxide or the like can be used, but it is preferable to use an aqueous solution of an organic alkali since it is easy to remove alkaline component at firing. As the organic alkali, generally-used amine compounds can be used. Concretely, tetramethyl ammonium hydroxide, trimethyl benzyl ammonium hydroxide, monoethanol amine, diethanol amine or the like are mentioned. Concentration the aqueous alkaline solution is, generally, 0.01 to 10 wt %, and more preferably, 0.1 to 5 wt %. If the alkali concentration is too low, soluble portion may not be removed and if the alkali concentration is too high, patterned portion may be peeled off or insoluble portion may be deteriorated. Furthermore, it is preferable that temperature at the development is carried out at 20 to 50° C., in view of process control.

As to the shape of the barrier rib pattern obtainable after the development, in case where the top width of the top of main barrier rib after firing is to be made 40 μm or less, it is preferable to form the width before firing of the portion corresponding to the top of main barrier rib in 60 μm or less. In case where it is larger than 60 μm, the width of the top of main barrier rib. after firing becomes larger than 40 μm, i.e., since it becomes too thick, the discharge space is narrowed to lower the brightness.

Furthermore, in case where such a barrier rib pattern is formed, it is preferable to form a barrier rib in such a way that the relation between the width of the top of main barrier rib, Wa, and the width of the top of auxiliary barrier rib, Wb, satisfies the following equation (2).

Wb/Wa≧1.2 (2)

In order to satisfy the above equation (2), in the barrier rib pattern before firing, it is preferable to make the exposing width of the portion corresponding to the auxiliary barrier rib to 1.2 times or more of the exposing width of the portion corresponding to the main barrier rib.

Next, the pattern of the main barrier rib and the auxiliary barrier rib obtained by the development is implemented to a firing by a firing furnace. The firing atmosphere or temperature is different depending on kind of the paste or the substrate, but the firing is carried out in an atmosphere such as of air, nitrogen and hydrogen. As the firing furnace, a batch firing furnace or a roller-hearth type continuous kiln can be used. It is preferable to carry out at the firing temperature of 400 to 800° C. In case where a barrier rib is formed directly on a glass substrate, it is better to maintain at a temperature of 450 to 620° C. for 10 to 60 minutes.

Subsequently, phosphor layers emitting respective colors of R (red), G (green) and B (blue) are formed between barrier ribs formed in parallel direction to the predetermined address electrodes. It is possible to form the phosphor layer by coating between predetermined barrier ribs, a phosphor paste of which main components are a phosphor powder, an organic binder and an organic solvent, and drying and, as required, firing.

As methods for coating the phosphor paste between the predetermined barrier ribs, phosphor pastes of respective colors can be coated to predetermined positions by a screen printing method in which a pattern printing is carried out by a screen printing plate, a dispenser method in which a phosphor paste is discharged in a pattern via a tip of discharge nozzle, or, a photosensitive paste method in which the above-mentioned organic component having a photosensitivity is used as an organic binder of the phosphor paste, but for the reason of cost, the screen printing method or the dispenser method is preferably employed in the present invention.

When the thickness of R phosphor layer is expressed as Tr, the thickness of G phosphor layer is expressed as Tg, and the thickness of B phosphor layer is expressed as Tb, by preferably having relations of 10 μm≦Tr≦Tb≦50 μm, and 10 μm≦Tg≦Tb≦50 μm, it is possible to exhibit the effect of the present invention further. That is, for the blue color of which brightness is low, by making its thickness thicker than those of the green color and the red color, it is possible to make a plasma display of which color balance is more excellent (color temperature is high). Making the thickness of the phosphor layer 10 μm or more can obtain a sufficient brightness. Furthermore, by making it 50 μm or less, it is possible to secure a wide discharge space to achieve a high brightness. The thickness of the phosphor layer mentioned here is determined as the thickness formed at the center position of neighboring barrier ribs. That is, it is determined as the thickness of the phosphor layer formed at the bottom portion of the discharge space (inside the cell). It is possible to prepare the member for plasma display of the present invention by firing the coated phosphor layer at 400 to 550° C. as required.

By using this member for plasma display as a rear panel, after sealing and bonding with a front panel, in the space formed between the front and the rear substrates, a discharge gas composed such as of helium, neon or xenon is enclosed, and then a plasma display can be made by providing with a drive circuit. The front panel is a member in which a transparent electrode, bus electrodes, a dielectric layer and a protective film (MgO) are formed in a predetermined pattern on a substrate. Color filter layers may be formed at positions corresponding to the respective phosphor layers of RGB colors formed on the rear panel. Furthermore, in order to improve contrast, black stripes may be formed.

### EXAMPLE

Hereafter, the present invention is explained concretely with reference to examples. However, the present invention is not limited thereto.

### Method of Evaluation

(1) Width of top of main barrier rib, Wa (μm), and width of top of auxiliary barrier rib, Wb (μm)

They were measured by a microscope (produced by Hirox).

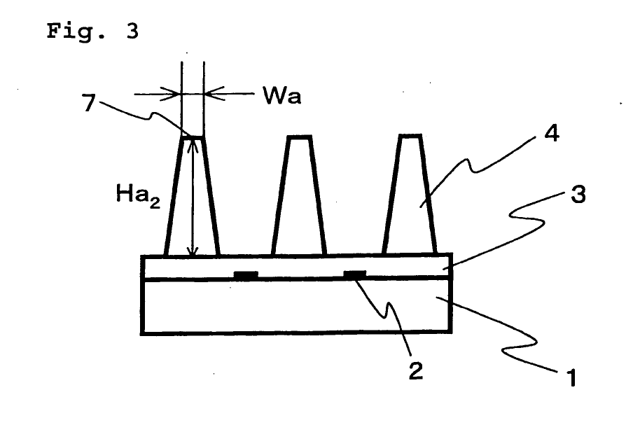

As the width of the top of main barrier rib, Wa (μm), the main barrier rib width at the center position of the neighboring auxiliary barrier ribs as shown in FIGS. 2 and 3, and as the width of the top of auxiliary barrier rib, Wb (μm), the auxiliary barrier rib width at the center position of the neighboring main barrier ribs as shown in FIG. 2 were measured, respectively.

The measurements were carried out at each 10 points in display, and their average value was employed, respectively.

(2) Height of main barrier rib at intersection, Ha₁ (μm), height of main barrier rib in partitioning portion, Ha₂ (μm), and height of auxiliary barrier rib, Hb (μm)

As the height of main barrier rib at intersection, Ha₁ (μm), the height at the center position of the intersections of the main barrier rib and the auxiliary barrier rib as shown in FIG. 2, as the height of the main barrier rib in partitioning portion, Ha₂ (μm), the height in center position of the neighboring auxiliary barrier ribs and at the center position of width direction of the main barrier rib as shown in FIGS. 2 and 3, and the height of said auxiliary barrier rib, Hb (μm), the height of the center position of the neighboring main barrier ribs and the center position of width direction of the auxiliary barrier rib as shown in FIG. 2, were measured by a ultradeep-type microscope (produced by Keyence) as shown in FIG. 2.

The measurements were carried out at 10 points in display, respectively, and averaged.

From the above-measured result, Ha₂−Ha₁ (μm) was determined, and difference in level of the main barrier rib was evaluated in the following criteria.

Difference in level of main barrier rib

Bad: Ha₂−Ha₁<0 (μm) (many defective indications occurs by erroneous discharge)

Excellent: 0≦Ha₂−Ha₁≦2 (μm) (a defective indication is most unlikely to occur)

Good: Ha₂−Ha₁>2 (μm) (a defective indication may occur depending on position).

### Example 1

Address electrodes were formed on a glass substrate, PD200 (size: 964×570 mm), by using a photosensitive silver paste. By carrying out coating of the photosensitive silver paste, drying, exposure, development and firing steps, address electrodes of a line width of 20 μm, a thickness of 3 μm and a pitch of 100 μm were formed. Next, a glass paste obtained by kneading 60 wt % of a low melting point glass powder containing bismuth oxide (75 wt % in the glass), 10 wt % of titanium oxide powder of average particle diameter of 0.3 μm, 15 wt % of ethyl cellulose, 15 wt % of terpineol was coated 20 μm in thickness by a screen printing to cover the bus electrodes of the display, and then, a dielectric layer was formed by carrying out firing at 570° C. for 15 minutes.

A photosensitive paste was coated on the dielectric layer. The photosensitive paste was composed of a glass powder and an organic component containing a photosensitive component, and as the glass powder, a glass powder of an average particle diameter of 2 μm obtained by grinding a glass having a composition of lithium oxide of 10 wt %, silicon oxide of 25 wt %, boron oxide of 30 wt %, zinc oxide of 15 wt %, aluminum oxide of 5 wt % and calcium oxide of 15 wt % was used. As the organic component containing a photosensitive component, 30 wt % of a component composed of an acrylic polymer containing carboxylic group, 30 wt % of trimethylol propane triacrylate, 10 wt % of “Irgacure 369” (produced by Ciba-Geigy K.K.) which is a photopolymerization initiator and 30 wt % of γ-butyrolactone was used.

The photosensitive paste was prepared by kneading by a roll mill after mixing the glass powder and the organic component containing the photosensitive component in a weight ratio of 70:30.

Next, this photosensitive paste was coated by a die coater in such a way that the coated width and dried thickness would be 530 mm and 200 μm, respectively. The drying was carried out. by a clean oven (produced by Yamato Scientific Co., Ltd.). After the drying, a photomask in which a stripe pattern having exposing portion of a pitch of 200 μm, a width of 60 μm and a length of 920 mm was prepared, the longitudinal direction of the stripe pattern of the photomask was arranged perpendicular to the longitudinal direction of the above-mentioned address electrodes and an exposure operation with the photomask and the substrate positioned was carried out at an exposure intensity of 20 mW/cm², for an exposure time of 20 seconds and at a distance between the photomask and the coating film on the substrate (gap size) of 100 μm.

Then, the photosensitive paste was coated again by using a die coater in such a way that the coated width and dried thickness would be 80 mm and 30 μm, respectively. The drying was carried out by a clean oven (produced by Yamato Scientific Co., Ltd.) A photomask in which a stripe pattern having exposing portion of a pitch of 100 μm, a width of 40μm and a length of 536mm was prepared, and the longitudinal direction of the stripe pattern of the photo mask was arranged parallel to the longitudinal direction of the above-mentioned address electrodes and an exposure operation with the photomask and the substrate positioned was carried out at an exposure intensity of 20 mW/cm², for an exposure time of 20 seconds and at a distance between the photomask and the coated film on the substrate (gap size) of 100 μm. After the exposure, by developing in 0.5 wt % aqueous solution of ethanol amine, and further, by firing at 580° C. for 15 minutes, a member for plasma display having a lattice-like barrier rib was obtained. Characteristics of the obtained member for plasma displays are shown in Table 1. The Wb/Wa was 1.5 and the difference in level of the main barrier rib was 2 μm and it was a barrier rib having a good shape.

### Examples 2 to 5 and Comparative Examples 1 to 3

Members for plasma displays were obtained in the same way as Example 1 except changing the first and second coating thicknesses (dried thickness) of the photosensitive paste, and except changing the widths of the photomask employed in the first exposure and the second exposure as those of Table 1. Characteristics of the obtained members for plasma displays are shown in Table 1. The Wb/Wa in Example 2 was 2.5 and the difference in level of the main barrier rib was slightly large was 5 μm, that is slightly larger than that in Example 1 but it was a level of no problem in practical use. Wb/Wa of Examples 3 and 4 was 1.3, Wb/Wa of Example 5 was 1.5, Wb/Wa of Example 6 was 1.4 and differences in level of the respective main barrier ribs were 1 μm, 4 μm, 5 μm and 2 μm. As to Examples 4 and 5, the differences in level of the main barrier rib were slightly large since the values of Ha₂−Hb were large, but they were levels of no problem in practical use. In the members for plasma display of Comparative examples 1, 2 and 3, the values of Wb/Wa were less than 1.2, and there were problems since the heights of main barrier rib at the partitioning portion were low.

TABLE 1

| | Coating thickness of the | | | | | | | | | | | |
|---|---|---|---|---|---|---|---|---|---|---|---|---|
| | photosensitive paste | | Width of the | | | | | | | | | |
| | (dried thickness) (μm) | | exposing portion | | Width at top | Width at top of | | | | | | Difference in |
| | | Second | of the photomask (μm) | | of the main | the auxiliary | | | | | | level of main |
| | First coating | coating | First | Second | barrier rib | barrier rib | | Ha₁ | Ha₂ | Hb | Ha₂-Hb | barrier rib |
| | thickness | thickness | exposure | exposure | Wa (μm) | Wb (μm) | Wb/Wa | (μm) | (μm) | (μm) | (μm) | (Ha₂-Ha₁) |
| Example 1 | 200 | 30 | 60 | 40 | 40 | 60 | 1.5 | 148 | 150 | 143 | 7 | Excellent |
| | | | | | | | | | | | | (2) |
| Example 2 | 185 | 65 | 70 | 28 | 28 | 70 | 2.5 | 143 | 148 | 133 | 15 | Good |
| | | | | | | | | | | | | (5) |
| Comarative | 185 | 65 | 30 | 30 | 30 | 30 | 1 | 161 | 150 | 135 | 15 | Bad |
| example 1 | | | | | | | | | | | | (−11) |
| Comarative | 190 | 40 | 44 | 40 | 40 | 44 | 1.1 | 156 | 149 | 140 | 9 | Bad |
| example 2 | | | | | | | | | | | | (−7) |
| Example 3 | 200 | 30 | 52 | 40 | 40 | 52 | 1.3 | 151 | 152 | 145 | 7 | Excellent |
| | | | | | | | | | | | | (1) |
| Example 4 | 185 | 65 | 52 | 40 | 40 | 52 | 1.3 | 147 | 151 | 136 | 15 | Good |
| | | | | | | | | | | | | (4) |
| Example 5 | 85 | 108 | 60 | 40 | 40 | 60 | 1.5 | 144 | 149 | 124 | 25 | Good |
| | | | | | | | | | | | | (5) |
| Comarative | 200 | 30 | 35 | 32 | 32 | 35 | 1.1 | 154 | 150 | 143 | 7 | Bad |
| example 3 | | | | | | | | | | | | (−4) |
| Example 6 | 200 | 30 | 45 | 32 | 32 | 45 | 1.4 | 146 | 148 | 141 | 7 | Excellent |
| | | | | | | | | | | | | (2) |

1. A member for display comprising nearly stripe-like address electrodes on a substrate, a dielectric layer covering the address electrode, and a lattice-like barrier rib present on the dielectric layer consisting of a main barrier ribs which are approximately parallel to said address electrodes and auxiliary barrier ribs which intersect with the main barrier ribs, wherein the member for display is characterized in that a width at top of said main barrier rib, Wa (μm), and a width at top of said auxiliary barrier rib, Wb (μm), satisfy the following equations (1) and (2).
Wa≦40 (1)
2.0≧Wb/Wa≧1.2 (2)

2. The member for display according to claim 1, wherein a height of said main barrier rib at a center position of neighboring said auxiliary barrier ribs, Ha₂ (μm), and a height of said auxiliary barrier rib, Hb (μm), satisfy the following equation (3).
Ha₂−Hb<20 (3)

3. The member for display according to claim 1, wherein the height of said main barrier rib at the center position of neighboring said auxiliary barrier ribs, Ha₂ (μm), and the height of said auxiliary barrier rib, Hb (μm), satisfy the following equation (4).
Ha₂−Hb<10 (4)

4. A production method for a member for display in which a lattice-like barrier rib consisting of main barrier ribs which are approximately parallel to address electrodes and auxiliary barrier ribs which intersect with the main barrier ribs are formed, including covering a nearly stripe-like address electrodes on a substrate with a dielectric layer, coating of a glass paste containing a low melting point glass powder and an organic component on the dielectric layer to form a lattice-like barrier rib pattern consisting of the glass paste coating film, and firing the coating film wherein said method for producing the member for display is characterized in that a width of the top of said main barrier rib, Wa (μm), and a width of the top of said auxiliary barrier rib, Wb (μm), are patterned in such a way that the following equations (1) and (2) are satisfied.
Wa≦40 (1)
2.0≧Wb/Wa≧1.2 (2)
